(19) United States
(12) Patent Application Publication
(10) Pub. No.: US 2013/0162541 A1
(43) Pub. Date: Jun. 27, 2013

(54) CONTROL KEY ASSEMBLY FOR PORTABLE ELECTRONIC DEVICE

(71) Applicants: ZHEN-LIN LIU, Shenzhen City (CN); HUI-TAO QIU, Shenzhen City (CN); WEN-ZE LIU, Shenzhen City (CN)

(72) Inventors: ZHEN-LIN LIU, Shenzhen City (CN); HUI-TAO QIU, Shenzhen City (CN); WEN-ZE LIU, Shenzhen City (CN)

(21) Appl. No.: 13/632,226

(22) Filed: Oct. 1, 2012

(30) Foreign Application Priority Data
Dec. 27, 2011 (CN) 201110444169.2

(51) Int. Cl. G06F 3/02

(52) U.S. Cl. 345/169

(57) ABSTRACT

A key assembly is assembled to an electronic device. The electronic device includes a housing. The key assembly includes a number of keys and an elastic bracket. The keys are received in the housing. The elastic bracket includes a main plate and a plurality of pairs of pressing fingers extending from the main plate. Each pair of the pressing fingers press one of the keys for mounting the keys between the housing and the elastic bracket.

### BACKGROUND

1. Technical Field

The present disclosure relates to a control key assembly applied to portable electronic devices.

2. Description of Related Art

Many portable electronic devices, such as mobile phones, have a housing defining an interior compartment for receiving a printed circuit board (PCB). The devices often include a plurality of control key assemblies on one side of the housing, allowing one-handed operation of the device. However, each control key assembly needs to be melted/locked on the housing. The assembly process is complicate. Additionally, each control key assembly has low flexibility which greatly affects the operation of the control key assemblies.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an exploded view of an exemplary embodiment of a control key assembly.

FIG. 2 is similar to FIG. 1, but shown from another aspect.

FIG. 3 is a partially assembled view of the control key assembly shown in FIG. 1.

FIG. 4 is an assembly view of the control key assembly shown in FIG. 1.

### DETAILED DESCRIPTION

The disclosed control key assembly may be applied in portable electronic devices such as mobile phones or personal digital assistants in accordance with an exemplary embodiment. In the exemplary embodiment, the control key assembly being used in a mobile phone is illustrated, although the disclosure is not limited thereto.

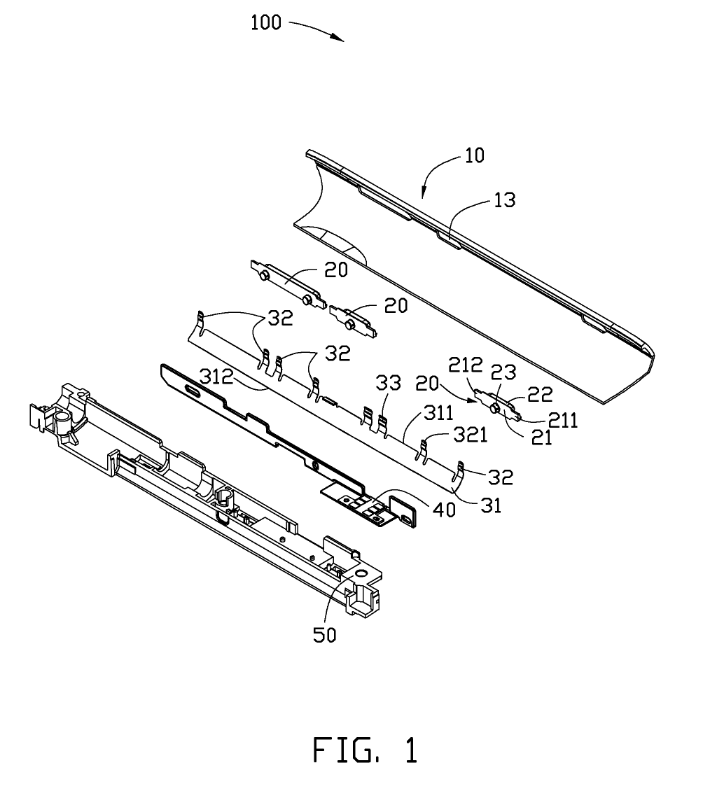

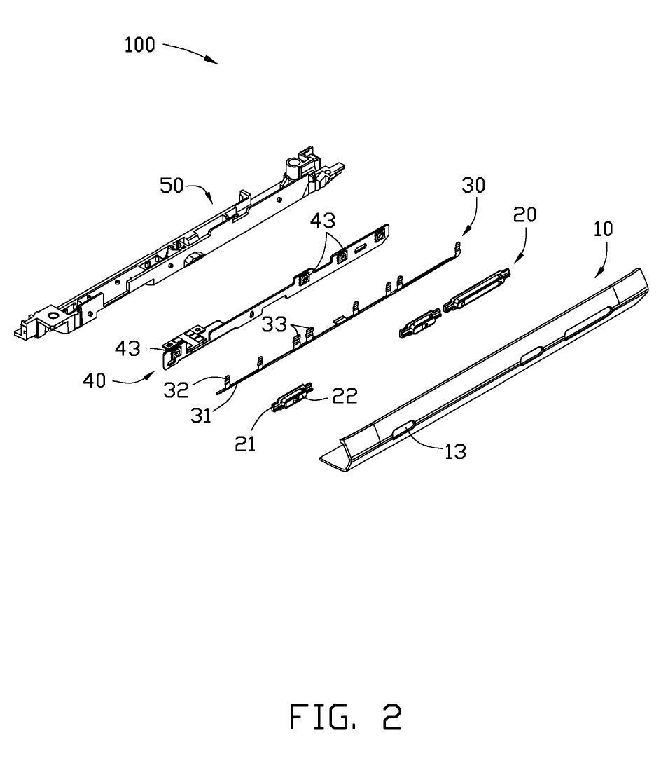

Referring to FIGS. 1 and 2, an exemplary embodiment of one part of an electronic device 100 is shown. The electronic device 100 includes a housing 10, a plurality of keys 20, an elastic bracket 30, a printed circuit board 40 and a main body 50.

The housing 10 defines a plurality of key holes 13. In the exemplary embodiment, there are three key holes 13.

The keys 20 are assembled into the key holes 13. In the exemplary embodiment, there are three keys 20, respectively a volume key, a lock key and a capture key. Each key 20 includes a key body 21, a key cap 22 and at least one post 23. The key body 21 is made of elastic material such as silicone, and includes a first end 211 and a second end 212. The key cap 22 is made of hard material such as plastic, and is mounted on one side of the key body 21. The key cap 22 extends into a corresponding key hole 13 to be exposed from the housing 10. The post 23 is mounted on another side of the key body 21. The printed circuit board 40 includes a plurality of contacts 43. When the key cap 22 is pressed, the post 23 can contact one of the contacts 43 of the printed circuit board 40 to trigger an input signal.

The elastic bracket 30 includes a main plate 31, a plurality of pairs of pressing fingers 32, at least one pair of resisting fingers 33. The main plate 31 includes a first edge 311 and a second edge 312. The pressing fingers 32 and the resisting fingers 33 extend from the first edge 311. In the exemplary embodiment, there are three pairs of pressing fingers 32 respectively configured for latching three keys 20. The arrangement of the pressing fingers 32 corresponds to the distance of the three keys 20. Each pair of the pressing fingers 32 is used for latching the first end 211 and the second end 212 of each key 20. Each latching finger 32 has an arcuate end 321 for providing more elasticity. The resisting fingers 33 are used for resisting the housing 10 to stably mount the elastic bracket 30.

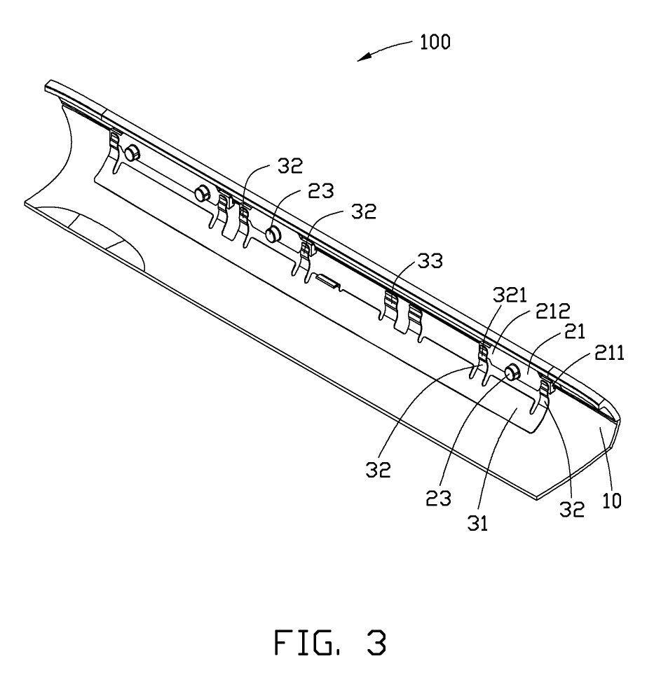

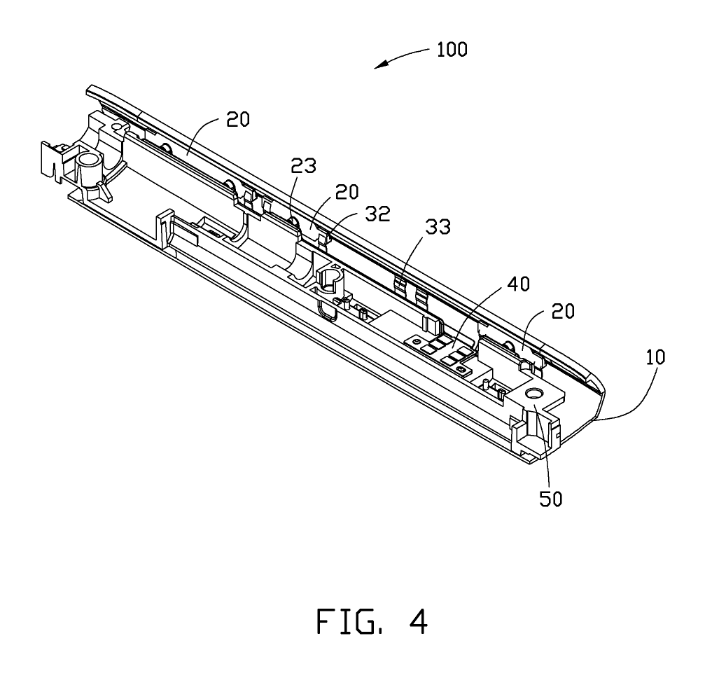

Referring to FIGS. 3 and 4, the electronic device 100 can be but is not limited to be assembled in the following steps.

During assembly of the electronic device 100, each key 20 is assembled to a corresponding key hole 13. The key cap 22 of one of the keys 20 extends from the key hole 13 to be exposed from the housing 10. Then, the main plate 31 of the elastic bracket 30 is mounted on the housing 10 with weld or hot melt. The resisting fingers 33 abut against the housing 10. One of each pair of the pressing fingers 32 elastically presses the first end 211 of the key body 21, the other of each pair of the pressing fingers 32 elastically presses the second end 212 of the key body 21. The assembly processes of the other keys 20 are similar to the above. The keys 20 are positioned by the key holes 13 and the pressing fingers 32. Thus, the keys 20 are assembled to the housing 10. After that, the printed circuited board 40 is attached to the main body 50. The assembled housing 10 is positioned on the main body 50, and faces the printed circuited board 40. Each key 20 corresponds to at least one contact 43. As such, the electronic device 100 is assembled.

In use, the key cap of one of the keys 20 is pressed to force the key body 21 to elastically deform. The key body 21 further moves the pressing fingers 32 pressing the key body 21 to elastically deform. The post 23 contacts a corresponding contact 43 of the printed circuited board 40, thereby performing a corresponding function. When the key cap 22 at a pressed state is released, the pressing fingers 32 and the key body 21 return back to an initial state. The pressing fingers 32 are not only used for mounting the key 20, but also provide more elasticity for the keys 20, the keys 20 can provide a comfortable operation for users.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A key assembly assembled to an electronic device, the electronic device including a housing, the key assembly comprising:
a plurality of keys received in the housing; and
an elastic bracket including a main plate and a plurality of pairs of pressing fingers extending from the main plate, each pair of the pressing fingers pressing one of the keys for mounting the keys between the housing and the elastic bracket.

2. The key assembly as claimed in claim 1, wherein each key includes a key body, a key cap and at least one post, the key body includes a first end and a second end, the key cap is mounted on one side of the key body, and the post is mounted on another side of the key body.

3. The key assembly as claimed in claim 2, wherein the key body is made of elastic material, the key cap is made of hard material.

4. The key assembly as claimed in claim 1, wherein the elastic bracket includes at least one pair of resisting fingers, the resisting fingers resist the housing.

5. An electronic device comprising:
a housing defining a plurality of key holes;
a plurality of keys received in the key holes; and
an elastic bracket including a main plate and a plurality of pairs of pressing fingers extending from the main plate, each pair of the pressing fingers pressing one of the keys for mounting the keys between the housing and the elastic bracket.

6. The electronic device as claimed in claim 5, wherein each key includes a key body, a key cap and at least one post, the key body includes a first end and a second end, the key cap is mounted on one side of the key body, and the post is mounted on another side of the key body.

7. The electronic device as claimed in claim 6, wherein the key body is made of elastic material, the key cap is made of hard material.

8. The electronic device as claimed in claim 7, wherein the elastic bracket includes at least one pair of resisting fingers, the resisting fingers resist the housing.
